(19) United States
(12) Patent Application Publication
(10) Pub. No.: US 2023/0138331 A1
(43) Pub. Date: May 4, 2023

(54) MOTION IN IMAGES USED IN A VISUAL INSPECTION PROCESS

(71) Applicant: INSPEKTO A.M.V. LTD., RAMAT GAN (IL)

(72) Inventors: YONATAN HYATT, TEL-AVIV (IL); ALEXANDER SPIVAK, HADERA (IL); MICHAEL GOTLIEB, RAANANA (IL)

(21) Appl. No.: 17/766,338

(22) PCT Filed: Sep. 29, 2020
(86) PCT No.: PCT/IL2020/051060

§ 371 Date: Apr. 4, 2022

Related U.S. Application Data
(60) Provisional application No. 62/911,487, filed on Oct. 7, 2019.

(30) Foreign Application Priority Data
Oct. 7, 2019 (IL) 269899

(51) Int. Cl. G06T 7/00; G06T 7/215

(52) U.S. Cl. CPC G06T 7/0004; G06T 7/215; G06T 2200/24; G06T 2207/20208

(57) ABSTRACT

Embodiments of the invention provide a visual inspection process in which motion is detected in an image of an item on an inspection line and the origin of the motion is determined. Determining the origin of motion in an image enables to provide a user with specific and clear indications on how to eliminate motion in the images and thus facilitates the visual inspection process.

### FIELD

The present invention relates to visual inspection processes, for example, inspection of items on a production line.

### BACKGROUND

Inspection during production processes helps control the quality of products by identifying defects and acting upon their detection, for example, by fixing them or discarding the defected part, and is thus useful in improving productivity, reducing defect rates, and reducing re-work and waste.

Automated visual inspection methods are used in production lines to identify, from images of inspected items, detectable anomalies that may have a functional or esthetical impact on the integrity of a manufactured part.

When using automated visual inspection, image quality affects the ability of a processor running algorithms for inspection, to reliably carry out inspection tasks, such as, defect detection, quality assurance (QA), sorting and/or counting, gating, etc.

In a typical inspection environment, there are many moving parts. Thus, images obtained in an inspection environment typically include motion and as a result, many images may be blurry and not suitable for defect detection and other inspection tasks.

### SUMMARY

Embodiments of the invention provide a system and method for determining when low or no motion images can be captured during a visual inspection process, enabling to supply high quality images for inspection tasks.

In one embodiment, a motion pattern in images can be learned from previously captured images of an item on an inspection line. The timing of capturing an image with low or no motion, can be calculated based on the learned motion pattern.

In other embodiments a processor detects motion in an image of the item on the inspection line and can determine the origin of the motion. Determining the origin of motion in an image enables to provide a user (e.g., inspection line operator) with specific and clear indications on how to eliminate motion in the images and thus facilitates the visual inspection process.

### BRIEF DESCRIPTION OF THE FIGURES

The invention will now be described in relation to certain examples and embodiments with reference to the following illustrative figures so that it may be more fully understood. In the drawings:

FIG. 1 schematically illustrates a system operable according to embodiments of the invention;

FIG. 2 schematically illustrates a camera assembly mounted on an inspection line, according to embodiments of the invention;

FIG. 3 schematically illustrates a method for visual inspection of an item, according to an embodiment of the invention;

FIG. 4 schematically illustrates a method for visual inspection of an item, using input from a motion detector, according to an embodiment of the invention;

FIG. 5 schematically illustrates a user interface device according to embodiments of the invention; and

FIG. 6 schematically illustrates a method for visual inspection of an item, using pre-learned motion patterns, according to an embodiment of the invention.

### DETAILED DESCRIPTION

A production line visual inspection process, typically occurring at a manufacturing plant, may include a setup stage and an inspection stage. In the setup stage two or more samples of a manufactured item of the same type, (in some embodiments, the samples are items with no defects), are placed in succession within a field of view (FOV) of (one or more) camera. For example, an inspection line may include a conveyor belt on which the inspected items are placed, such that movement of the conveyor belt brings the inspected items into the FOV of the camera in succession. Images of the items may be displayed to a user, such as a technician, inspector and/or inspection line operator.

Images of the samples of items obtained during the setup stage, may be referred to as setup images or reference images. Reference images may be obtained by using, for each image, different imaging parameters of the camera, for example different focuses and exposure times. The setup images are analyzed to collect information, such as, spatial properties and discriminative features of the type of item being imaged. Spatial properties may include, for example, 2D shapes and 3D characteristics of an item. Discriminative features typically include digital image features (such as used by object recognition algorithms) that are unique to an item. This analysis during the setup stage enables to discriminatively detect a same type of item (either defect free or with a defect) in a new image, regardless of the imaging environment of the new image, and enables to continually optimize the imaging parameters with minimal processing time during the following inspection stage.

Instructions to a user regarding adjustment of camera and/or illumination parameters can be displayed to the user, e.g., via a user interface device. Once it is determined, based on the analysis of the reference images, that enough information about the item is obtained, the setup stage may be concluded and a notification is displayed or otherwise presented to a user, to stop placing samples on the inspection line and/or to place inspected items on the inspection line to begin the inspection stage.

In the inspection stage that follows the setup stage, inspected items, which are of the same type as the sample items and which may or may not have defects, are imaged in succession. These images, which may be referred to as inspection images, are analyzed using computer vision techniques (e.g., machine learning processes) to detect defects in the items and other inspection tasks such as quality assurance (QA), sorting and/or counting, etc.

A setup stage may be performed initially, prior to the inspection stage, and/or during the inspection stage.

Although a particular example of a setup procedure or stage of a visual inspection process is described herein, it should be appreciated that embodiments of the invention may be practiced with other setup procedures of visual inspection processes.

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “analyzing”, “processing,” “computing,” “calculating,” “determining,” “detecting”, “identifying”, “creating”, “producing”, or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices. Unless otherwise stated, these terms refer to automatic action of a processor, independent of and without any actions of a human operator.

The terms “item” and “object” may be used interchangeably and are meant to describe the same thing.

The term “same-type items” or “same-type objects” refers to items or objects which are of the same physical makeup and are similar to each other in shape and dimensions and possibly color and other physical features. Typically, items of a single production series, batch of same-type items or batch of items in the same stage in its production line, may be “same-type items”. For example, if the inspected items are sanitary products, different sink bowls of the same batch are same-type items.

A defect may include, for example, a visible flaw on the surface of the item, an undesirable size of the item or part of the item, an undesirable shape or color of the item or part of the item, an undesirable number of parts of the item, a wrong or missing assembly of interfaces of the item, a broken or burned part, and an incorrect alignment of the item or parts of the item, a wrong or defected barcode, and in general, any difference between the defect-free sample and the inspected item, which would be evident from the images to a user, namely, a human inspector. In some embodiments a defect may include flaws which are visible only in enlarged or high resolution images, e.g., images obtained by microscopes or other specialized cameras.

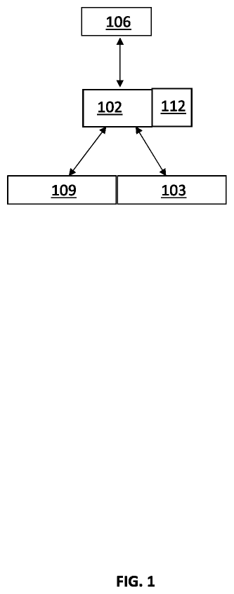

An exemplary system which may be used for visual inspection of an item on an inspection line, according to embodiments of the invention, is schematically illustrated in FIG. 1. The exemplary system includes a processor 102 in communication with one or more camera(s) 103 and with a device 106, such as a graphic user interface (GUI) device and/or possibly with other processors or controllers and/or other devices, such as a storage device. A storage device may be a server including for example, volatile and/or non-volatile storage media, such as a hard disk drive (HDD) or solid-state drive (SSD). The storage device may be connected locally or remotely, e.g., in the cloud. In some embodiments, a storage device may include software to receive and manage image data related to reference images.

In some embodiments processor 102 may communicate with a controller, such as a programmable logic controller (PLC), typically used in manufacturing processes, e.g., for data handling, storage, processing power, and communication capabilities. In some embodiments the processor 102 is in communication with a user interface device and/or other devices, directly or via the PLC.

Components of the system may be in wired or wireless communication and may include suitable ports and cabling and/or network hubs.

Processor 102 may include, for example, one or more processors and may be a central processing unit (CPU), a graphics processing unit (GPU), a digital signal processor (DSP), a field-programmable gate array (FPGA), a microprocessor, a controller, a chip, a microchip, an integrated circuit (IC), or any other suitable multi-purpose or specific processor or controller. Processor 102 may be locally embedded or remote, e.g., in a server on the cloud.

The device 106, which may be a user interface device, may include a display, such as a monitor or screen, for displaying images, instructions and/or notifications to a user (e.g., via text or other content displayed on the monitor). A user interface device may also be designed to receive input from a user. For example, the user interface device may include a monitor and keyboard and/or mouse and/or touch screen, to enable a user to input feedback or other data.

Camera(s) 103, which are configured to obtain an image of an inspection line, are typically placed and fixed in relation to the inspection line (which may include, e.g., a conveyer belt), such that items placed on the inspection line are within the FOV of the camera 103.

Camera 103 may include a CCD or CMOS or other appropriate chip. The camera 103 may be a 2D or 3D camera. In some embodiments, the camera 103 may include a standard camera provided, for example, with mobile devices such as smart-phones or tablets. In other embodiments the camera 103 is a specialized camera, e.g., a camera for obtaining high resolution images.

A motion sensing device 109, such as a gyroscope and/or accelerometer may be attached to or otherwise in connection with the camera 103. Motion sensing device 109 may also be in communication with processor 102 and may provide input to processor 102. Motion sensing device 109 and/or camera 103 may be in communication with a clock or counter that records passage of time.

The system may also include a light source, such as an LED or other appropriate light source, to illuminate the camera FOV, e.g., to illuminate an item on the inspection line.

In some embodiments, camera 103 (and possibly the light source) may be attached to or mounted on the inspection line, e.g., the camera may be fixed in relation to a conveyer belt, using a mount. Motion of the conveyor belt, for example, or other parts of the inspection line, can translate, via the mount, to movement or vibrations of the camera. The mount and/or camera may be provided with stabilizers for vibration damping, however, some movement or vibrations of the camera and/or of the item on the conveyor belt may occur.

Processor 102 receives image data (which may include data such as pixel values that represent the intensity of reflected light as well as partial or full images or videos) of objects on the inspection line from the one or more camera(s) 103 and runs processes according to embodiments of the invention.

Processor 102 is typically in communication with a memory unit 112. Memory unit 112 may store at least part of the image data received from camera(s) 103.

Memory unit 112 may include, for example, a random access memory (RAM), a dynamic RAM (DRAM), a flash memory, a volatile memory, a non-volatile memory, a cache memory, a buffer, a short term memory unit, a long term memory unit, or other suitable memory units or storage units.

In some embodiments the memory unit 112 stores executable instructions that, when executed by processor 102, facilitate performance of operations of processor 102, as described herein.

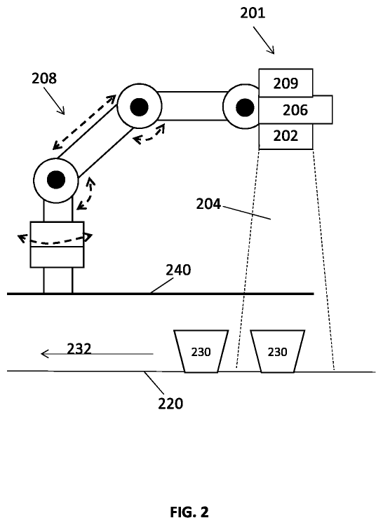

In one embodiment, which is schematically illustrated in FIG. 2, a camera assembly 201 includes a camera 202 and possibly additional components, such as, optics, a distance measuring device, a light source 206 and a motion detector 209. The camera assembly 201 can be positioned using a mounting assembly 208 such that at least one of items 230 is within the FOV 204 of camera 202. Mounting assembly 208, which includes rotatable and/or adjustable parts, as indicated by the dashed arrows, is attached to a mounting surface 240. Surface 240 optionally comprises an aluminum profile including grooves for attachment of mounting brackets, and can include a pipe or rod of any shape. Surface 240 may remain in a fixed position relative to item 230 or alternatively may move so as to repeatedly bring camera assembly 201 into a position where items 230 are within the field of view 204 of camera 202. A non-limiting example of a movable mounting surface 240 is a robotic arm. Alternatively, items 230 may be placed on an inspection line 220 which supports and moves items 230 such as but not limited to a conveyor belt, or a cradle or another holding apparatus, moving in direction 232 while camera assembly 201 remains stationary, such that first item 230 is brought into FOV 204 followed by a second item 230 which is brought into FOV 204, and so forth. Alternatively, items 230 are successively placed in FOV 204 and then removed such as by a robot or human operator. Although the embodiments herein are shown as being on a horizontal conveyor moving in direction 232, other options for surface 240 and inspection lines may be implemented.

Each item 230 is within the field of view 204 of the camera 202 for a certain amount of time, termed here an “inspection window”. An inspection line typically operates to repetitively run inspection windows. An inspection window may last several seconds, which means, depending on the frame capture rate of the camera 202, that several images of each item 230 are captured in each inspection window.

Movement of inspection line 220 and/or of other parts of the inspection environment may impart movement to items 230 and/or to camera assembly 201, e.g., via surface 240 or mounting assembly 208. Camera 202 and/or camera assembly 201 may move for other reasons. Thus, some of the images captured during the inspection window may be captured while camera 202 and/or item 230 are not yet still, and may thus be blurry and not suitable for defect detection or other inspection tasks.

Motion detector 209, which may include any suitable motion sensor, such as a gyroscope and/or accelerometer, is attached to camera 202 or otherwise connected to camera 202, e.g., via the camera assembly 201, and as such, detects movement of the camera 202. Input from motion detector 209 to a processor may be used to determine motion of camera 202.

Items 230 may also show motion in images, either due to movement imparted by elements in the inspection environment or due to moveable parts within the item or other properties of the item itself

Movement which causes blurriness in an image of an item, can prevent successful visual inspection of the item. Thus, avoiding images captured during movement of the camera and/or item is important for visual inspection of the item. Determining the origin of motion in an image can be useful in advising a user how to reduce the motion and allow successful inspection.

An inspection environment, which typically includes conveyor belts, engines, moving arms, etc., is typically full of motion. Therefore, an image captured in this environment will typically always include motion. Therefore, embodiments of the invention apply motion detection on limited or specified areas in the image, rather than on the whole image. The limited area in the image may be a region of interest (ROI), for example, the area of an item or an area within the item. For example, an ROI may be an area on the item in which a user requires defect detection.

In one embodiment, a processor, such as processor 102 automatically detects an ROI, e.g., by using image analysis techniques. Pixels associated with an ROI, e.g., pixels associated with an item, may be determined by using image analysis algorithms such as segmentation. In some embodiments, processor 102 may receive indications of an outline (e.g., boarders) of the item or other ROI from a user and may determine which pixels are associated with the item (or other ROI), possibly using segmentation and based on the boarders of the item (or other ROI).

In some cases, motion in an image of an item on an inspection line is small enough so that it doesn't cause a blur and does not interfere with the visual inspection. Typically, it is required that combined motion of the camera and item be less than a threshold after which blurriness occurs. This threshold may be dependent on sensitivity of the inspection system (e.g., sensitivity of camera 103 or 202 and/or of the defect detection algorithms run by processor 102). The threshold can be determined, for example, in the setup stage of an inspection process, when different images are captured by the camera using different imaging parameters.

Thus, motion that causes blurriness is typically composed of a component of camera motion and a component of item motion. Isolating each component can provide insight to the origin of the motion and therefore, can be useful in advising a user how to overcome motion that creates blurriness in inspection images.

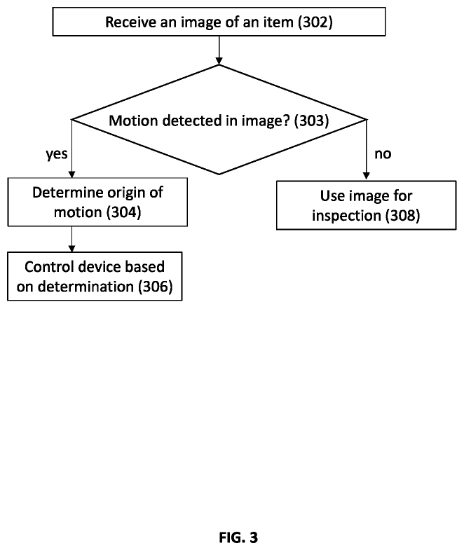

In one embodiment, which is schematically illustrated in FIG. 3, a method for visual inspection of an item, includes receiving an image of the item on the inspection line (302). If motion is detected in the image (303) an origin of the motion is determined (304), e.g., whether the motion originated from movement of a camera used to capture the image or from motion of the imaged item. A device is controlled, based on the determination of the origin of motion (306). The device controlled based on the determination of the origin of motion may include, for example, a part of the inspection line environment, such as a camera or moving arm attached to the camera or camera assembly, a user interface device, or other devices or processors of devices, as further described below.

If no motion or motion below a threshold, is detected in the image (303) then the image is used for inspection tasks, such as defect detection (308).

Motion can be detected in an image, for example, by applying an image processing algorithm on the image. For example, optical flow methods and registration of consecutive images, can be used to detect motion in an image. In one example, the image can be compared to a predefined grid or reference to detect deviations from the reference. Deviations from the reference can be translated to motion within the image. Typically, these methods are applied to a specified ROI in the image, e.g., location of the item and/or within boundaries of the item.

As discussed above, motion detected in an image may be due to movement of the camera or due to other reasons, such as movement of the imaged item or movement of part(s) of the item.

In some embodiments, image processing can be used to determine the origin of motion detected in an image. For example, if movement is detected by an algorithm (e.g., as described above) in all or most parts of the image, that can indicate that the motion originated from the camera. However, if motion is detected in only a few parts of the image, that can indicate that the movement originated from the item itself. In one embodiment, the location of the item in the image is known so that image processing can be used to determine motion in the area of the item and in an area of the image outside of the item. If motion is detected in the area of the item but not in other areas of the image, it can be determined that the origin of the motion is from the item itself.

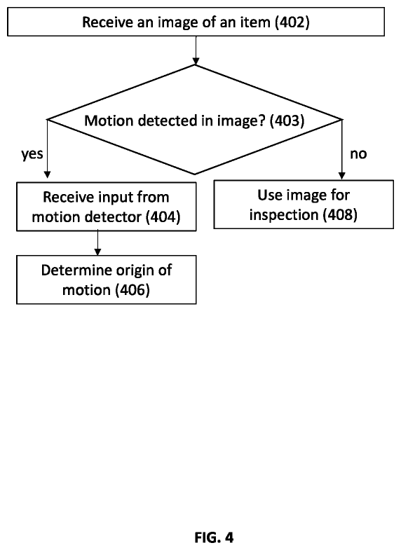

In one embodiment, which is schematically illustrated in FIG. 4, a determination whether the motion detected in an image originated from movement of the camera, can be obtained based on input from a motion detector attached to the camera, such as motion detector 209. A processor receives an image of an item on an inspection line (402). If no motion or motion below a threshold, is detected in the image (403) then the image is used for inspection tasks, such as defect detection (408).

If motion is detected in the image (403), e.g., motion above a threshold, input is received from a motion detector (404) and the origin of the motion is determined based on the input from the motion detector (406).

For example, input from the motion detector can be used to create a graph of movement measurements (e.g., amplitude) over time. The time of capture of an image can be compared to the graph to determine if there was movement of the camera at the time of capture of the image.

Motion originating from camera movement can be overcome by changing the zoom and/or distance of the camera from the imaged item. The higher the zoom, the more sensitive the system will be to motion. Similarly, the closer the camera is to the item the more sensitive the system will be to movement. The zoom of the camera may be communicated from the camera 103 to the processor 102. Processor 102 may then calculate a new zoom value which would prevent blurriness. Similarly, the distance of the camera 202 from the item (e.g., from item 230 or from inspection line 220) may be known, e.g., based on user input and/or based on an optimal focus measured by camera 202 and/or based on input from a distance measuring device, such as a laser distance measuring device that can be, for example, attached to camera assembly 201. The known distance can be used by processor 102 to calculate a new distance which would prevent blurriness. The new values calculated by processor 102 can be displayed to a user on a user interface device (e.g., device 106). Thus, a notice to a user may include information about changing the zoom of the camera or the distance of the camera from the item.

Motion originating from the imaged item may be overcome, for example, by adjusting the ROI to exclude moving parts of the item, by changing an orientation of the item on the inspection line, etc.

As mentioned above, a device is controlled based on the determination of the origin of motion, e.g. based on determination that the motion originated from movement of the camera.

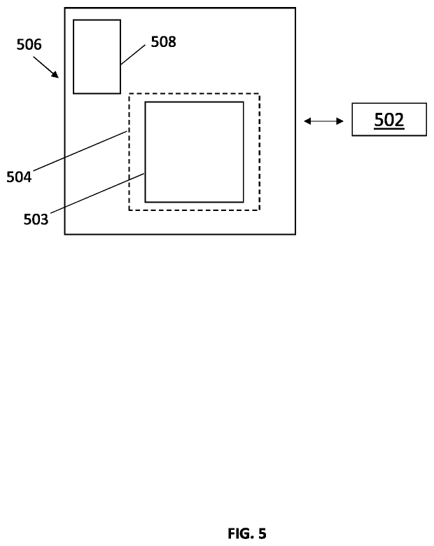

In one embodiment, which is schematically illustrated in FIG. 5 the device may include a user interface device. A display 506 of a user interface device is in communication with a processor 502. The display may include an image window 503 (e.g., in which to display a setup image or an inspection image). In some embodiment the display includes a “camera movement” indicator 504, which may be a pop up window or other alert appearing on display 506 together with image window 503. For example, the indicator 504 may include a visible line or other shape surrounding the image displayed in image window 503 or an arrow or other graphic symbol indicating at the image. In some embodiments a sound or light or other noticeable alert may be initiated in addition to or instead of indicator 504.

In one example, processor 502 causes a notification 508 to be displayed on a display 506 of a user interface device. The notification 508 may be a text or graphic message, e.g., in a window, indicating the origin of the motion as determined by processor 502. In a case where movement in the image was above a threshold, the notification 508 may include an indication that the item was not inspected.

In some cases, the notification 508 may include an indication of an action to be done by a user, to reduce the motion.

In some embodiments, a processor running image processing algorithms may be controlled based on the determination that motion detected in an image originated from movement of the camera. For example, image processing algorithms for detecting defects on items may be applied to images of items on an inspection line but not to images which include motion originating from movement of the camera. In one embodiment, the image processing algorithms may include obtaining a high definition range (HDR) image of the item and inspecting the item in the HDR image. For example, the algorithm may include obtaining a plurality of images of the inspection line from a camera having a dynamic range, each image having a different exposure value; comparing pixel values of the images to the dynamic range of the camera to determine a minimal number of optimal images based on the comparison; and combining the minimal number of optimal images to obtain an HDR image of the item on the inspection line. In a case where it is determined that images include motion originating from camera movement, it would be necessary to wait until the camera movement stops in order to obtain useable images. Waiting for camera movement to stop and then obtaining a plurality of images per item, could require too much time, rendering the algorithm impractical for inspection tasks. In this case, the processor (e.g., processor 102) and/or the PLC may decide not to apply an image processing algorithm to obtain an HDR image, based on the determination that an image includes motion originating from camera movement. This control of algorithms applied during the inspection process may be automatic and may affect which inspection processes will be carried out (e.g., inspection with HDR or without). In some embodiments, a notification 508 is displayed to a user regarding which inspection processes will or will not be carried out, e.g., regarding use of an HDR image, based on the determination that an image includes motion originating from camera movement.

Determining an origin of motion in an image can be done both in the setup stage and/or in the inspection stage. Notification 508 can be displayed on a user interface device during a setup stage, prior to an inspection stage and/or during the inspection stage.

In some embodiments the device controlled based on the determination of the origin of motion, may include a PLC. For example, a PLC can be controlled to specifically handle images in which motion above a threshold was determined. For example, the PLC can be controlled to save images for automatic re-analysis once camera or item motion issues have been corrected. Alternatively or in addition, a PLC can issue alerts to specific users (e.g., specific technicians) based on the determined origin of motion. For example, if the origin of motion is the camera a technician may be alerted whereas if the origin of the motion is the item, an inspection line operator may be alerted.

In some embodiments, operation of the camera used to capture the image, can be controlled, e.g., to time capturing of images to times when the camera and/or item are not moving or moving minimally, under a threshold.

Since an inspection line operates in a substantially repetitive pattern, movement patterns of the camera and/or item on the inspection line can be learned over time and this information can be extrapolated to predict future movement patterns of the camera and/or item and timing of images with minimal motion.

In one embodiment, operation of the camera can be controlled in correlation with the learned and/or extrapolated movement pattern in images. A method for visual inspection of an item from images of the item on an inspection line which were captured during a current inspection window, may include determining a motion pattern in images captured in a previous inspection window, and controlling the timing of capture of an image by a camera, within the current inspection window, based on the motion pattern.

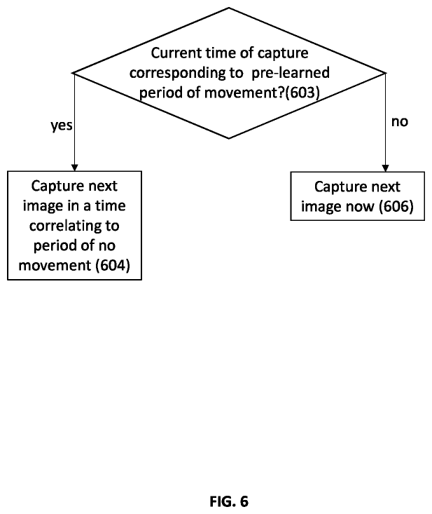

In an example schematically illustrated in FIG. 6, a processor determines if a current time corresponds to a period of movement above or below a threshold in previously learned and extrapolated movement patterns in images. Movement patterns in images can be determined from image processing, by applying image processing algorithms on the images, as described above. In one embodiment image processing algorithms are applied specifically on an ROI within the image, e.g., on an area of the item in the image. Movement patterns in images may be based on learned patterns of movement of a camera and/or of an imaged item. For example, a motion pattern in images can be determined by receiving input from a motion detector that is in communication with the camera.

If the current time corresponds to a period of movement above a threshold in a previously learned pattern (603), then the camera is controlled to wait and capture a next image, within a current inspection window, in another time, which corresponds to a period of no movement (or movement below the threshold) in the previously learned pattern (604). If the period of no movement in the previously learned pattern falls outside of the current inspection window, the processor may adjust the duration of the inspection window to allow for at least one image with no motion to be captured within the inspection window.

If the current time corresponds to a period of movement below a threshold in a previously learned pattern (603), the camera is controlled to capture an image in the current time (606).

In some embodiments, a movement pattern in images and/or movement pattern of the camera and/or items, can be learned and extrapolated during a setup stage. Then, during the inspection stage the timing of image capture by the camera may be controlled according to the pattern determined in the setup stage.

Thus, methods, systems and GUIs according to embodiments of the invention, enable producing precise indications to a user, thereby facilitating the user's interaction with the inspection process.

1. A visual inspection system comprising a processor to apply an image processing algorithm on an image of an item on an inspection line, the processor configured to:
receive an image of the item on the inspection line, captured by a camera;
detect motion in the image;
obtain a determination of the origin of the motion;
control a display of a user interface device, based on the determination.

2. The system of claim 1 wherein the camera is mounted on the inspection line.

3. The system of claim 1 wherein the origin of motion is from the camera or from the item.

4. The system of claim 1 wherein the processor is configured to receive input from a motion detector attached to the camera and wherein the determination of the origin of motion is obtained based on the input from the motion detector.

5. The system of claim 4 wherein the motion detector comprises a gyroscope and/or an accelerator.

6. The system of claim 1 wherein the processor is configured to cause a notification to be displayed on the display of the user interface device, the notification indicating the origin of the motion.

7. The system of claim 1 wherein the processor is configured to cause a notification to be displayed on the display of the user interface device, the notification indicating that the item was not inspected.

8. The system of claim 1 wherein the processor is configured to cause a notification to be displayed on the display of the user interface device, the notification indicating an action to be done by a user, to reduce the motion.

9. The system of claim 1 wherein the processor is configured to cause a notification to be displayed on the display of the user interface device, the notification to be displayed during a set up stage, prior to an inspection stage.

10. The system of claim 1 wherein the processor is configured to control a programmable logic controller (PLC), based on the determination.

11. The system of claim 1 wherein the processor is configured to control the image processing algorithm when motion is detected in the image.

12. The system of claim 11 wherein the image processing algorithm comprises obtaining a high dynamic range (HDR) image of the item and inspecting the item in the HDR image.

13. The method of claim 12 wherein the processor is configured to cause a notification regarding use of the HDR image, to be displayed on the display of the user interface device.

14. The system of claim 1 wherein the processor is configured to detect motion in the image, by applying an image processing algorithm on the image.

15. (canceled)

16. The system of claim 1 wherein the processor is configured to detect the item in the image and detect the motion at a location of the item in the image.

17-24. (canceled)

25. A method for visual inspection of an item from images of the item on an inspection line, the images captured during a current inspection window, the method comprising:
using a processor to determine a motion pattern in images captured in a previous inspection window;
controlling timing of capture of an image by a camera, within the current inspection window, based on the motion pattern.

26. The method of claim 25 wherein determining a motion pattern in images comprises receiving at the processor input from a motion detector that is in communication the camera.

27. The method of claim 25 wherein determining a motion pattern in images comprises using the processor to apply image processing on the image.

28. The method of claims 27 comprising determining the motion pattern based on motion detected in an area of the item in the image.

29. The method of claim 25 comprising determining the motion pattern during a set up stage, prior to an inspection stage.
